(19) United States
(12) Patent Application Publication
(10) Pub. No.: US 2025/0278415 A1
(43) Pub. Date: Sep. 4, 2025

(54) RETRIEVAL AUGMENTED GENERATION BASED QUERY REFORMULATION PIPELINE FOR A QUESTION AND ANSWER SYSTEM

(71) Applicant: Salesforce, Inc., San Francisco, CA (US)

(72) Inventors: Phil Mui, San Francisco, CA (US); Ricky Ho, San Francisco, CA (US); Frank Wang, San Francisco, CA (US); Jesse Vig, New York, NY (US); Shafiq Rayhan Joty, San Francisco, CA (US)

(21) Appl. No.: 19/066,050

(22) Filed: Feb. 27, 2025

Related U.S. Application Data
(60) Provisional application No. 63/559,667, filed on Feb. 29, 2024.

(51) Int. Cl. G06F 16/332; G06F 16/901

(52) U.S. Cl. CPC G06F 16/3322; G06F 16/9024

(57) ABSTRACT

A retrieval augmented generation (RAG) based query reformulation pipeline for a Query and Answer (QA) system is described. This pipeline leverages a Directed Acyclic Graph (DAG) and involves several operations, including retrieval of documents and knowledge graph triplets based on the initial query, reranking of retrieved elements based on relevance, refinement and summarization of relevant document chunks and knowledge triplets, reformulation of the initial query, and generation of a natural language response. The response is generated using a large language model (LLM) and is grounded in the knowledge base, which supports factual accuracy and consistency.

### CROSS REFERENCE

The present application for patent claims priority to and the benefit of U.S. Provisional Patent Application No. 63/559,667 by Mui et al., entitled “RETRIEVAL AUGMENTED GENERATION BASED QUERY REFORMULATION PIPELINE FOR A QUESTION AND ANSWER SYSTEM,” filed Feb. 29, 2024, assigned to the assignee hereof, and expressly incorporated by reference in its entirety herein.

### FIELD OF TECHNOLOGY

The present disclosure relates generally to database systems and data processing, and more specifically to retrieval augmented generation (RAG) based query reformulation pipeline for a question and answer (QA) system.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

### BRIEF DESCRIPTION OF THE DRAWINGS

FIG. 1 illustrates an example of a data processing system that supports retrieval augmented generation (RAG) based query reformulation pipeline for a question and answer (QA) system in accordance with aspects of the present disclosure.

FIG. 2 shows an example of a query processing pipeline that supports RAG based query reformulation pipeline for a QA system in accordance with aspects of the present disclosure.

FIG. 3 shows an example of a query processing pipeline that supports RAG based query reformulation pipeline for a QA system in accordance with aspects of the present disclosure.

FIG. 4 shows a block diagram of an apparatus that supports RAG based query reformulation pipeline for a QA system in accordance with aspects of the present disclosure.

FIG. 5 shows a block diagram of a query and response manager that supports RAG based query reformulation pipeline for a QA system in accordance with aspects of the present disclosure.

FIG. 6 shows a diagram of a system including a device that supports RAG based query reformulation pipeline for a QA system in accordance with aspects of the present disclosure.

FIGS. 7 through 9 show flowcharts illustrating methods that RAG based query reformulation pipeline for a QA system in accordance with aspects of the present disclosure.

### DETAILED DESCRIPTION

Question and Answer (QA) systems, such as those that leverage large language models (LLMs), are designed to provide accurate and relevant responses to user queries, often leveraging complex algorithms and vast databases of information. However, a persistent challenge in this field is the ability to handle complex or ambiguous queries effectively. Traditional QA systems may struggle to identify the relevant information or understand the true intent behind such queries. This difficulty often results in responses that are either inaccurate or not fully satisfying to the user. The technical challenge, therefore, lies in developing a QA system that can effectively handle complex or ambiguous queries, accurately identify relevant information, and generate responses that are both accurate and satisfying to the user.

The present application introduces a Retrieval Augmented Generation (RAG) based Query Reformulation Pipeline for a QA system. This pipeline leverages a Directed Acyclic Graph (DAG) structure to process documents and knowledge graphs, ultimately returning natural language answers grounded in a defined knowledge base. The pipeline involves several operations, including retrieval of documents and knowledge graph triplets based on the initial query, reranking of retrieved elements based on relevance, refinement and summarization of relevant document chunks and knowledge triplets, reformulation of the initial query, and generation of a natural language response. The response is generated using an LLM and is grounded in the knowledge base, which supports factual accuracy and consistency. In some examples, the pipeline may be used to handle queries related to a wide range of topics, from general knowledge questions to complex technical queries. Thus, the RAG-based query reformulation pipeline addresses the technical challenge by effectively handling complex or ambiguous queries, accurately identifying relevant information, and generating accurate and satisfying responses. This is achieved through the combination of retrieval, generation, and knowledge graph capabilities within a DAG framework.

Aspects of the disclosure are initially described in the context of an environment supporting an on-demand database service. Aspects are further described in the process of query processing flows. Aspects of the disclosure are further illustrated by and described with reference to apparatus diagrams, system diagrams, and flowcharts that relate to RAG based query reformulation pipeline for a QA system.

Aspects of the disclosure are initially described in the context of an environment supporting an on-demand database service. Aspects are further described in the context of query processing pipelines. Aspects of the disclosure are further illustrated by and described with reference to apparatus diagrams, system diagrams, and flowcharts that relate to RAG based query reformulation pipeline for a QA system.

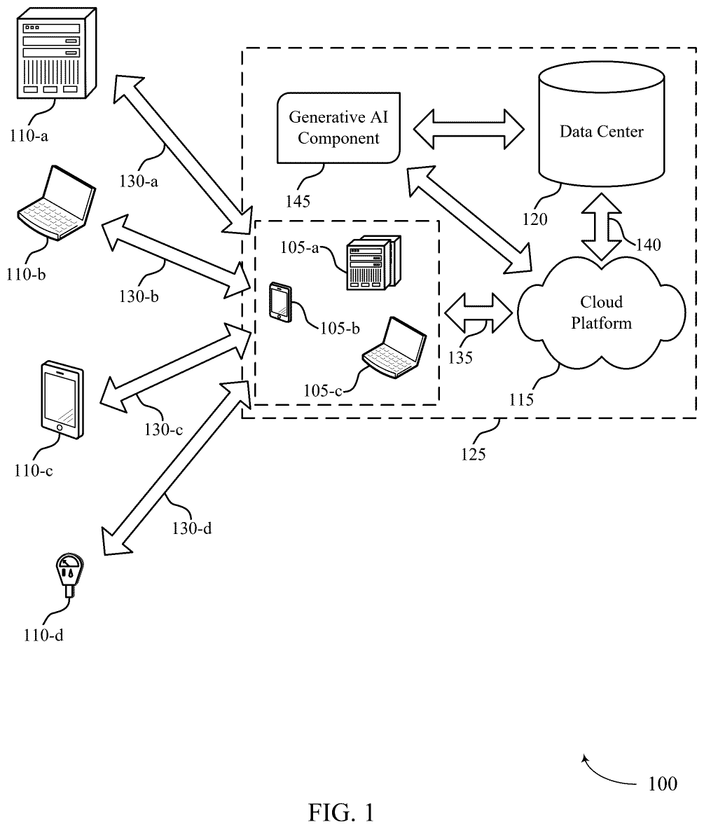

FIG. 1 illustrates an example of a system 100 for cloud computing that supports RAG based query reformulation pipeline for a QA system in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including-but not limited to-client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with the same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement RAG or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

The cloud platform 115, the subsystem 125, the generative AI component 145, or a combination thereof may support various services for contact 110 and/or cloud client 105 interaction. For example, the cloud platform 1115 may support a customer service chat bot (QA systems) that a cloud client 105 may implement or leverage to support interactions 130 with the contacts 110. In some examples, these chat bots may leverage generative artificial intelligence and/or LLM techniques to support these interactions, and these systems are designed to provide accurate and relevant responses to user queries, often leveraging complex algorithms and vast databases of information. However, a persistent challenge in this field is the ability to handle complex or ambiguous queries effectively. Traditional QA systems may struggle to identify the relevant information or understand the true intent behind such queries. This difficulty often results in responses that are either inaccurate or not fully satisfying to the user. The technical challenge, therefore, lies in developing a QA system that can effectively handle complex or ambiguous queries, accurately identify relevant information, and generate responses that are both accurate and satisfying to the user.

The present application introduces a RAG based Query Reformulation Pipeline for a QA system (e.g., implemented in the system 125 and/or the cloud platform 115). This pipeline leverages a DAG structure to process documents and knowledge graphs (e.g., stored in the data center 120), ultimately returning natural language answers grounded in a defined knowledge base. The pipeline involves several operations, including retrieval of documents and knowledge graph triplets based on the initial query, reranking of retrieved elements based on relevance, refinement and summarization of relevant document chunks and knowledge triplets, reformulation of the initial query, and generation of a natural language response. The response is generated using an LLM and is grounded in the knowledge base, which supports factual accuracy and consistency. In some examples, the pipeline may be used to handle queries related to a wide range of topics, from general knowledge questions to complex technical queries. Thus, the RAG-based query reformulation pipeline addresses the technical challenge by effectively handling complex or ambiguous queries, accurately identifying relevant information, and generating accurate and satisfying responses. This is achieved through the combination of retrieval, generation, and knowledge graph capabilities within a DAG framework.

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

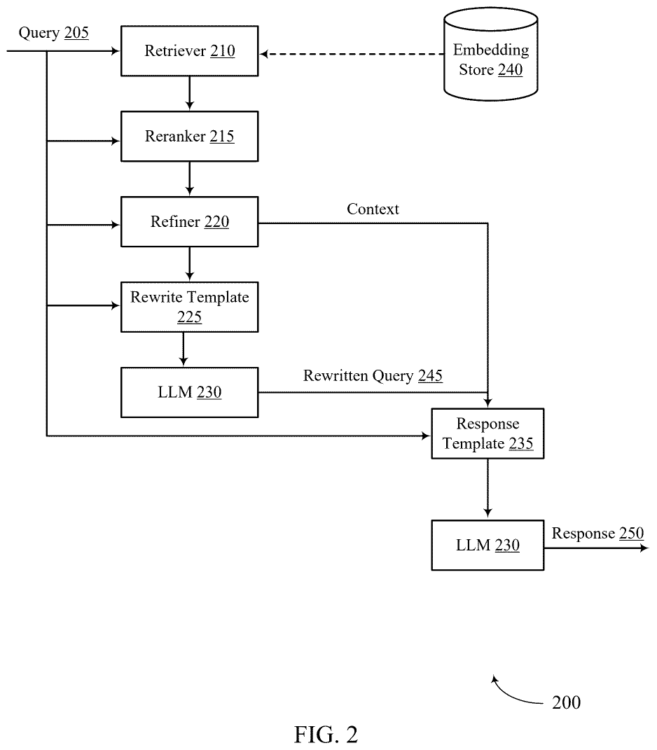

FIG. 2 shows an example of a query processing pipeline 200 that supports RAG based query reformulation pipeline for a QA system in accordance with aspects of the present disclosure. The query processor 200 may be an example of query processing in a smart mode for reformulating a query 205 in a broader context. The query processor 200 includes various components or nodes that perform various operations, and the query processor 200 may be implemented as a DAG, as described herein. The query 205 may be received based on a user interacting with a QA system (e.g., at a user interface), such as by entering one or more queries. The DAG may have the following nodes: a retriever 210, a reranker 215, a refiner 220, rewrite template 225 (e.g., rewrite_prompt), and LLM 230. Each node of the DAG may correspond to, define, or represent a set of instructions that are executed to perform the operations of the node.

Additionally, the edges of the DAG for the query processor 300 may be defined as follows, and the edges may represent how an output of one node is used as input into a next node:
query_str (query 205)=>retriever (retriever 210)
query_str (query 205)=>reranker (reranker 215)
query_str (query 205)=>refiner (refiner 220)
retriever (retriever 210)=>reranker (reranker 215)
reranker (reranker 215)=>refiner (refiner 220)
refiner (refiner 220)=>rewrite_prompt (rewrite template 225)
rewrite_prompt (rewrite template 225)=>llm (LLM 230)
refiner (refiner 220)=>response_prompt (response template 235)
llm (LLM 230)=>response_prompt (response template 235)
response_prompt (response template 235)=>llm (LLM 230)

Moreover, the output response from the query processor may be generated by inputting a generated modified prompt and using a response template 235 with a prompt as follows:

```
PromptTemplate(
  “answer the user's Query directly and succinctly with the Context.”
  “--------------------------------------\n”
  “Context: {context_str}\n”
  “--------------------------------------\n”
  “Query: {query_str} {rewritten_query_str}\n”
  “Answer: “
)
```

Thus, the response template may include placeholder elements or tags that are to be replaced for the final output/answer. That is, the contex_str tag may be replaced by the content string that is output by the refiner 220. Additionally the query_str tag may be replaced by the initial user query and the rewritten_query_str may be replaced by the rewritten query. Moreover, the LLM may output an answer that follows the “Answer:” string in the response template. The response template may include formatting elements “e.g., ----\n,” among other information.

In response to receiving the initial query 205, the retriever 210 may retrieve documents and knowledge graph triplets from an embedding store 240 based on the initial query 205 and using information retrieval techniques. For example, the retriever 210 may retrieve the documents and knowledge graph triplets based on semantic similarities of the documents and knowledge graph triplets to the query 205. Retrieval techniques may involve keyword-based retrieval, “multi-hop” retrieval, tree-based retrieval, or the like. In some examples, the retriever 210 may use vector embeddings to determine the semantic similarities (e.g., similarity in meaning or semantic content of documents, such as rather than lexicographical similarity) of the elements in the embedding store 240 to the query 205. That is, the embedding store 240 may store vector embeddings corresponding to the documents and knowledge graph triplets. The retriever 210 may compare the stored vector embeddings to a vector embedding of the query 205 (e.g., via cosine similarity, or another similarity comparison technique). Thus, in order to make the comparison, the retriever 210 or another component may generate a vector embedding based on the query 205, and the vector embedding may be compared to the vector embeddings corresponding to the documents and knowledge graph triplets to identify relevant information. The comparison may be based on a semantic similarity, which may be calculated using various semantic similarity techniques described herein, such as Cosine Similarity, Euclidean Distance, Manhattan Distance, etc.

The embedding store 240 may include one or more data stores of vector embeddings generated based on processing a corpus of documents. For example, a model (e.g., word embedding function) may be used to process each document of the corpus of documents and generate vectors corresponding to each document. In some cases, the documents are processed to generate knowledge graph triplets described herein, and each knowledge graph triplet may include a subject, a predicate (or relationship), and an object The basic structure follows the pattern: (Subject)-> [Predicate]-> (Object), where the subject is entity that is being described or is performing an action (typically a noun), the predicate is the relationship or property that connects the subject to the object (typically a verb or property), and the object is target entity or value that relates to the subject (can be another entity or a literal value). These knowledge graphs triplets may be stored in a knowledge graph and/or processed to generate corresponding vector embeddings. For example, the triplets may be processed using an embedding model described below to generate vector embeddings for knowledge graph triplets.

Additionally, the corpus of documents may be processed to generate vector embeddings such as by using an embedding model. This could be a pre-trained language model like Bidirectional Encoder Representations from Transformers (BERT), generative pre-trained transformer (GPT), or Word2Vec, or a custom-trained model for specific domains. The model processes the tokens either individually or in context (depending on the model architecture) and generates high-dimensional vectors that capture semantic meaning in documents. The document vectors and/or the vectorized knowledge graph triplets may be stored in the embedding store 240.

A relevance score may be assigned to each retrieved element based on its semantic similarity to the query. The reranker 215 may re-rank the retrieved elements based on the relevance score of each retrieved element and the contextual relevance of each retrieved element within the larger retrieved set. For example, the reranker 215 may, based on the relevance scores, sort the retrieved elements (e.g., documents and knowledge graph triplets) from most relevant to least relevant with respect to the query. The “contextual relevance” of each retrieved element may refer to the meaning and/or relationships of the element within the document or document(s) from which the element was retrieved. Additionally, or alternatively, the contextual relevance may refer to the meaning and/or relationships of the element across multiple documents or knowledge graph triplets (e.g., the meaning/relationships of the document the element is from relative to other documents). The refiner 220 may refine relevant document chunks and knowledge triplets (e.g., subject element, relationship element, object element) by extracting salient information and summarizing key points. For example, the refiner 220 may, for a quantity of most relevant documents (e.g., based on the re-ranked elements), extract information identified as being relevant based on the query. Additionally, the refiner 220 may summarize key points of information included in each element.

Based on the processed elements, the rewrite template 225 may reformulate the initial query to capture a deeper understanding of an intent of the user and clarify potential ambiguities. For example, the rewrite template 225 may revise the query 205 and generate a rewritten query 245 based on the refined document chunks and knowledge triplets. Put another way, the rewritten query 245 may better capture the intent of the user (e.g., compared to the query 205) based on using the retrieved, refined document chunks and knowledge triplets. The LLM 230 is then utilized to generate a natural language response 250 to the rewritten query 245. The answer/response 250 is grounded in the knowledge base, ensuring factual accuracy and consistency. For example, the rewritten query 245 may be used as input into the LLM 230 to generate a response 250 that includes more relevant information compared to the initial query 205. That is, because the rewritten query 245 is reformulated according to relevant, refined documents and knowledge triplets, the LLM 230 may be enabled to generate a more accurate response (e.g., compared to a response generated based on the initial query 205).

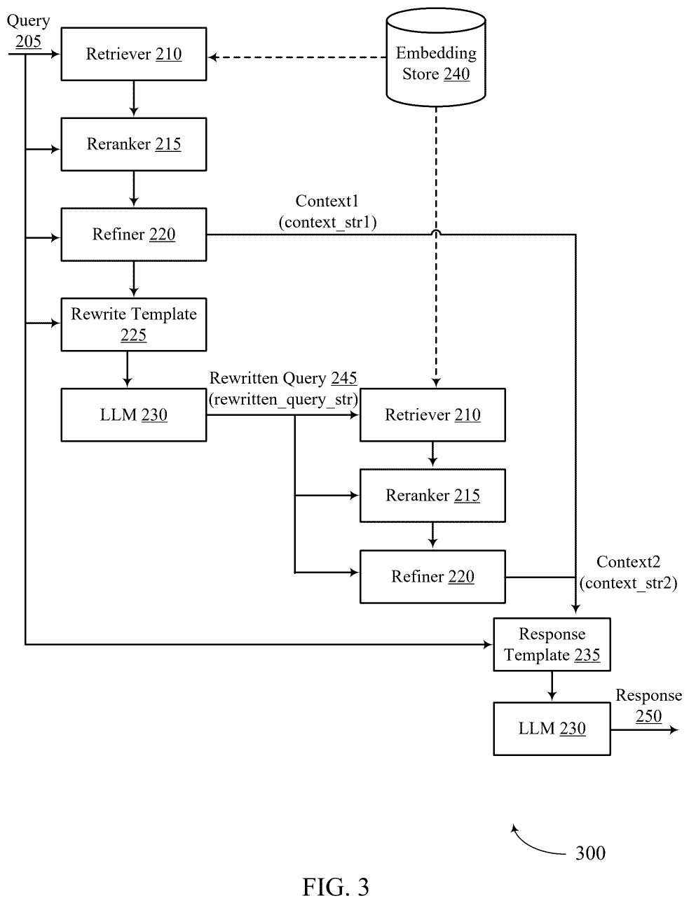

FIG. 3 shows an example of a query processing pipeline 300 that supports RAG based query reformulation pipeline for a QA system in accordance with aspects of the present disclosure. The query processor 300 may be an example of query processing in a thoughtful mode for reformulating the query to be broader in the same context, and the query processor 300 includes various components or nodes that perform various operations, and the query processor 300 may be implemented as a DAG, as described herein. For example, the DAG may have the nodes and edges as illustrated with respect to FIG. 3. Thus, in the smart mode, the DAG may utilize the nodes and edges (e.g., defining an order of processing) illustrated in FIG. 2. In the thoughtful mode, the DAG may utilize the nodes and edges (e.g., defining an order of processing) illustrated in FIG. 3.

For example, the query 205 may be processed and information elements may be obtained as described with respect to FIG. 2. In addition, after the query 205 is rewritten using the LLM 230 (e.g., to generate the rewritten query 245 in FIG. 2), information may be obtained based on the rewritten query 245 from the embedding store 240 (e.g., storing knowledge graphs and vectorized documents), and the information may be scored, reranked and refined again. The response template 235 again may be used and input into the LLM 230 to generate the final response 250.

These techniques may result in improved accuracy and relevance of answers compared to traditional QA systems, better handling of complex and ambiguous questions, the ability to adapt the response based on the intent of the user and background knowledge, and an increased interpretability and explainability of the answer due to grounding in the knowledge base. Thus, these techniques provide an improved RAG-based query reformulation pipeline for QA systems. This pipeline offers significant advantages over traditional approaches, leading to more accurate, relevant, and interpretable answers. By leveraging the strengths of information retrieval, knowledge graphs, and LLMs, these techniques support a significant advancement in the field of natural language processing and conversational AI.

As described herein, the pipeline may be constructed using the following components, elements, and systems:
1. VectorStoreIndex: This is the index of the documents that are used to retrieve relevant documents for a given query. The documents (e.g., a corpus of documents) are ingested into a vector store and indexed using the VectorStoreIndex. For example, the VectorStoreIndex may generate embedding vectors corresponding to each document and index the generated embedding vectors. The VectorStoreIndex is used to retrieve relevant documents for a given query.
2. RetrieverQueryEngine (Retriever 210): This is the query engine that is used to retrieve relevant documents for a given query. The RetrieverQueryEngine uses the VectorStoreIndex to retrieve relevant documents for a given query. For example, the RetrieverQueryEngine may identify embedding vectors in the VectorStoreIndex that are similar to (e.g., have a semantic similarity to) the query. That is, the RetrieverQueryEngine may retrieve vectors having a relatively small “distance” from a vector of the query. The RetrieverQueryEngine may use various techniques to determine similarity between vector embeddings. For example, the RetrieverQueryEngine may utilize Cosine Similarity, Euclidean distance Manhattan Distance, Word Mover's Distance, among other techniques. In some cases, the RetrieverQueryEngine may normalize vectors or perform other types of preprocessing techniques to determine vector similarity The RetrieverQueryEngine is used to retrieve relevant documents for a given query.
3. CustomQueryEngine: This is the query engine that is used to answer user queries. The CustomQueryEngine uses the RetrieverQueryEngine to retrieve relevant documents for a given query and uses the LLM to generate an answer to the user query. For example, the CustomQueryEngine may use the documents retrieved by the RetrieverQueryEngine to generate, via the LLM, an answer to the user query.
4. QueryPipeline: This is the query pipeline that is used to answer user queries. The QueryPipeline uses the CustomQueryEngine to answer user queries. For example, the QueryPipeline may include the CustomQueryEngine. The QueryPipeline is used to answer user queries.
5. LLM (LLM 230): This is the language model that is used to generate an answer to the user query. The LLM is used to generate an answer to the user query. The LLM may receive, as input, the relevant documents and the user query, and generate, as output, an answer to the user query.
6. PromptTemplate (Response Template 235): This is the template that is used to generate a prompt for the LLM. The PromptTemplate is used to generate a prompt for the LLM.
7. ResponseSynthesizer: This is the synthesizer that is used to generate a response to the user query. The ResponseSynthesizer is used to generate a response to the user query.
8. NodeParser: This is the node parser that is used to parse the nodes retrieved by the RetrieverQueryEngine. The NodeParser is used to parse the nodes retrieved by the RetrieverQueryEngine.
9. PostProcessor: This is the post processor that is used to post-process the nodes retrieved by the RetrieverQueryEngine. The PostProcessor is used to post-process the nodes retrieved by the RetrieverQueryEngine.
10. VectorStore (Embedding Store 240): This is the vector store that is used to store the vectors of the documents. The VectorStore is used to store the vectors of the documents.
11. IngestionPipeline: This is the ingestion pipeline that is used to ingest the documents into the vector store. The IngestionPipeline is used to ingest the documents into the VectorStore. For example, through the IngestionPipeline, the documents may be vectorized prior to being inputted to the VectorStore.

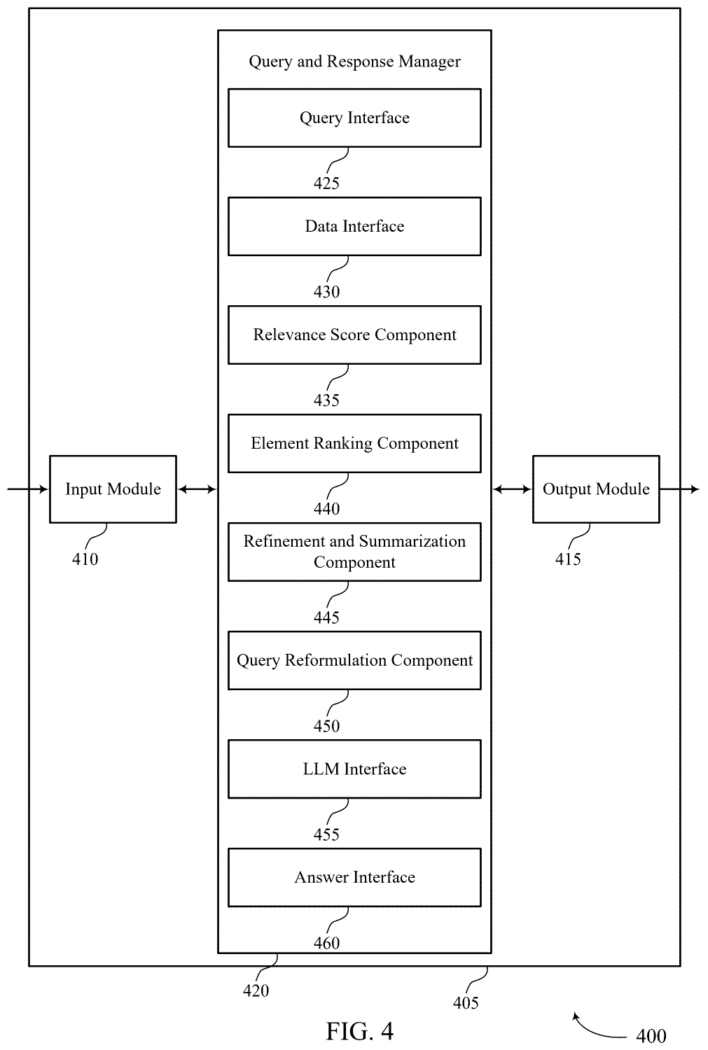

FIG. 4 shows a block diagram 400 of a device 405 that supports RAG based query reformulation pipeline for a QA system in accordance with aspects of the present disclosure. The device 405 may include an input module 410, an output module 415, and a query and response manager 420. The device 405, or one or more components of the device 405 (e.g., the input module 410, the output module 415, the query and response manager 420), may include at least one processor, which may be coupled with at least one memory, to support the described techniques. Each of these components may be in communication with one another (e.g., via one or more buses).

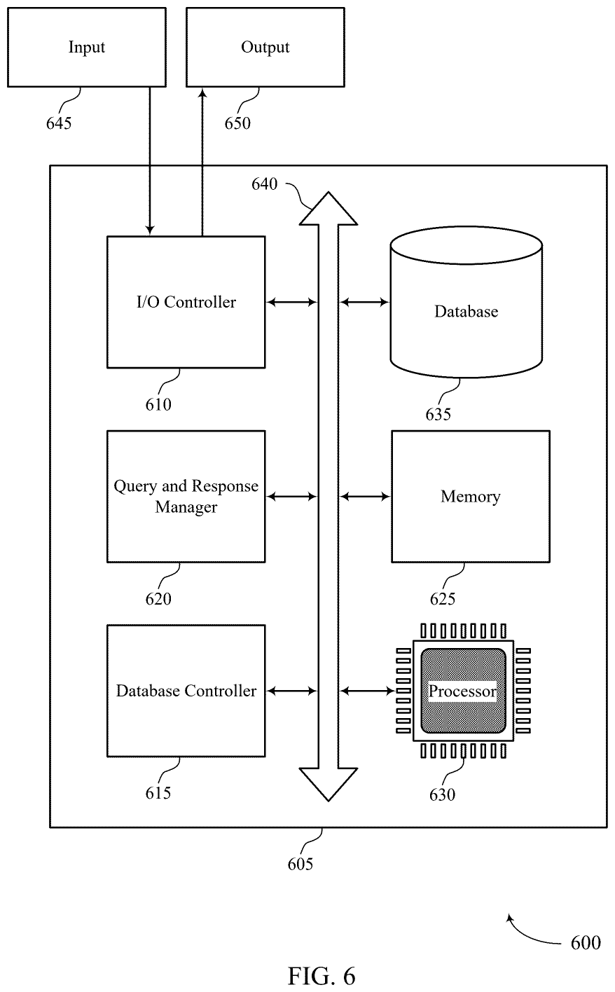

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the query and response manager 420 to support RAG based query reformulation pipeline for a QA system. In some cases, the input module 410 may be a component of an input/output (I/O) controller 610 as described with reference to FIG. 6.

The output module 415 may manage output signals for the device 405. For example, the output module 415 may receive signals from other components of the device 405, such as the query and response manager 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the query and response manager 420 may include a query interface 425, a data interface 430, a relevance score component 435, an element ranking component 440, a refinement and summarization component 445, a query reformulation component 450, an LLM interface 455, an answer interface 460, or any combination thereof. In some examples, the query and response manager 420, or various components thereof, may be configured to perform various operations (e.g., receiving, monitoring, transmitting) using or otherwise in cooperation with the input module 410, the output module 415, or both. For example, the query and response manager 420 may receive information from the input module 410, send information to the output module 415, or be integrated in combination with the input module 410, the output module 415, or both to receive information, transmit information, or perform various other operations as described herein.

The query interface 425 may be configured to support receiving at a QA system, a first user query. The data interface 430 may be configured to support obtaining, from one or more databases based on the first user query, a set of elements including one or more documents, one or more knowledge graph triplets, or both. The relevance score component 435 may be configured to support assigning, based on a respective semantic similarity between the first user query and each element of the set of elements, a respective relevance score to each element of the set of elements. The element ranking component 440 may be configured to support ranking the set of elements based on the respective relevance score assigned to each element of the set of elements. The refinement and summarization component 445 may be configured to support extracting additional information from each element of the set of elements based on the first user query. The query reformulation component 450 may be configured to support generating a second query based on the first user query and using the extracted additional information and the ranked set of elements. The LLM interface 455 may be configured to support inputting the generated second query into an LLM. The answer interface 460 may be configured to support returning an answer generated by the LLM as a response to the first user query.

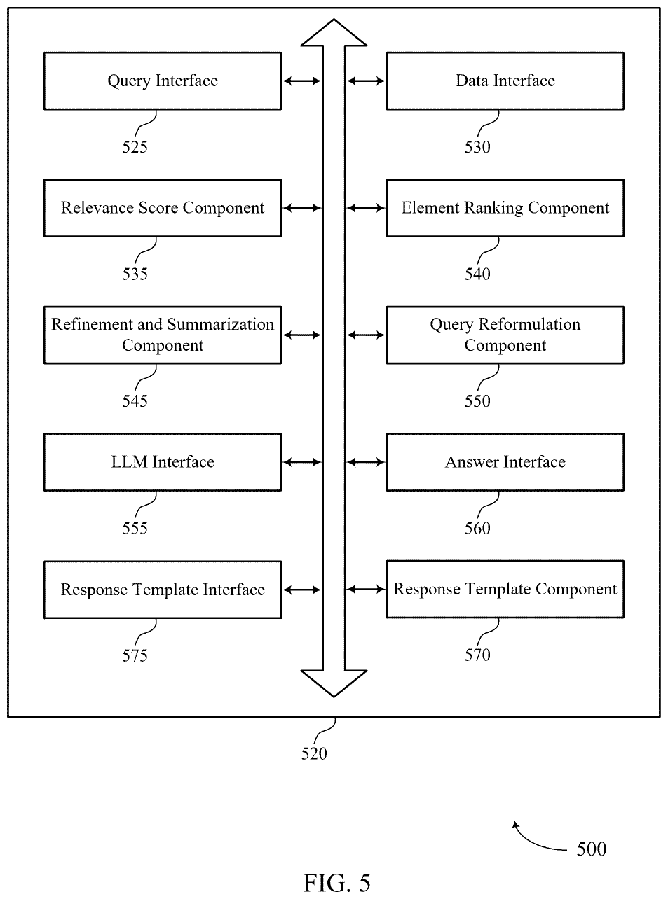

FIG. 5 shows a block diagram 500 of a query and response manager 520 that supports RAG based query reformulation pipeline for a QA system in accordance with aspects of the present disclosure. The query and response manager 520 may be an example of aspects of a query and response manager or a query and response manager 420, or both, as described herein. The query and response manager 520, or various components thereof, may be an example of means for performing various aspects of RAG based query reformulation pipeline for a QA system as described herein. For example, the query and response manager 520 may include a query interface 525, a data interface 530, a relevance score component 535, an element ranking component 540, a refinement and summarization component 545, a query reformulation component 550, an LLM interface 555, an answer interface 560, a response template component 570, a response template interface 575, or any combination thereof. Each of these components, or components of subcomponents thereof (e.g., one or more processors, one or more memories), may communicate, directly or indirectly, with one another (e.g., via one or more buses).

The query interface 525 may be configured to support receiving at a QA system, a first user query. The data interface 530 may be configured to support obtaining, from one or more databases based on the first user query, a set of elements including one or more documents, one or more knowledge graph triplets, or both. The relevance score component 535 may be configured to support assigning, based on a respective semantic similarity between the first user query and each element of the set of elements, a respective relevance score to each element of the set of elements. The element ranking component 540 may be configured to support ranking the set of elements based on the respective relevance score assigned to each element of the set of elements. The refinement and summarization component 545 may be configured to support extracting additional information from each element of the set of elements based on the first user query. The query reformulation component 550 may be configured to support generating a second query based on the first user query and using the extracted additional information and the ranked set of elements. The LLM interface 555 may be configured to support inputting the generated second query into an LLM. The answer interface 560 may be configured to support returning an answer generated by the LLM as a response to the first user query.

In some examples, the QA system includes a DAG structure configured to generate the second query based on the first user query.

In some examples, the QA system operates in accordance with a smart mode or thoughtful mode, and the DAG structure is dependent on whether the QA system is in the smart mode or the thoughtful mode.

In some examples, when operating in accordance with the smart mode, the DAG structure includes a first set of nodes. In some examples, when operating in accordance with the thoughtful mode, the DAG structure includes a second set of nodes.

In some examples, the data interface 530 may be configured to support obtaining, from the one or more databases and based on the rewritten query, a second set of elements including one or more second documents, one or more second knowledge graph triplets, or both. In some examples, the relevance score component 535 may be configured to support assigning, based on a respective semantic similarity between the rewritten query and each element of the second set of elements, a respective relevance score to each element of the second set of elements. In some examples, the element ranking component 540 may be configured to support ranking the second set of elements based on the respective relevance score assigned to each element of the second set of elements. In some examples, the refinement and summarization component 545 may be configured to support extracting second additional information from each element of the second set of elements based on the rewritten query, where the second additional information is input to the LLM and where the answer generated by the LLM is based on the second information.

In some examples, the one or more knowledge graph triplets are obtained from one or more knowledge graphs generated by the LLM from a corpus of documents. In some examples, each knowledge graph triplet includes a subject element, a relationship element, and an object element. A knowledge graph triplet may also be represented as “subject-predicate-object,” or (head, relation, tail). The knowledge graph triplet may represent graph data.

In some examples, to support inputting the generated second query into the LLM, the response template component 570 may be configured to support generating a response template including the generated second query, the first user query, the extracted additional information, and the ranked set of elements; where the response template includes formatting elements. In some examples, to support inputting the generated second query into the LLM, the response template interface 575 may be configured to support inputting the response template into the LLM, where the LLM generates the answer based on the response template.

FIG. 6 shows a diagram of a system 600 including a device 605 that supports RAG based query reformulation pipeline for a QA system in accordance with aspects of the present disclosure. The device 605 may be an example of or include components of a device 405 as described herein. The device 605 may include components for bi-directional data communications including components for transmitting and receiving communications, such as a query and response manager 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. Database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting RAG based query reformulation pipeline for a QA system). The processor 630 may be an example of a single processor or multiple processors. For example, the device 605 may include one or more processors 630.

For example, the query and response manager 620 may be configured to support receiving at a QA system, a first user query. The query and response manager 620 may be configured to support obtaining, from one or more databases based on the first user query, a set of elements including one or more documents, one or more knowledge graph triplets, or both. The query and response manager 620 may be configured to support assigning, based on a respective semantic similarity between the first user query and each element of the set of elements, a respective relevance score to each element of the set of elements. The query and response manager 620 may be configured to support ranking the set of elements based on the respective relevance score assigned to each element of the set of elements. The query and response manager 620 may be configured to support extracting additional information from each element of the set of elements based on the first user query. The query and response manager 620 may be configured to support generating a second query based on the first user query and using the extracted additional information and the ranked set of elements. The query and response manager 620 may be configured to support inputting the generated second query into an LLM. The query and response manager 620 may be configured to support returning an answer generated by the LLM as a response to the first user query.

By including or configuring the query and response manager 620 in accordance with examples as described herein, the device 605 may support techniques for improved query relevance and efficiency and improved user experience.

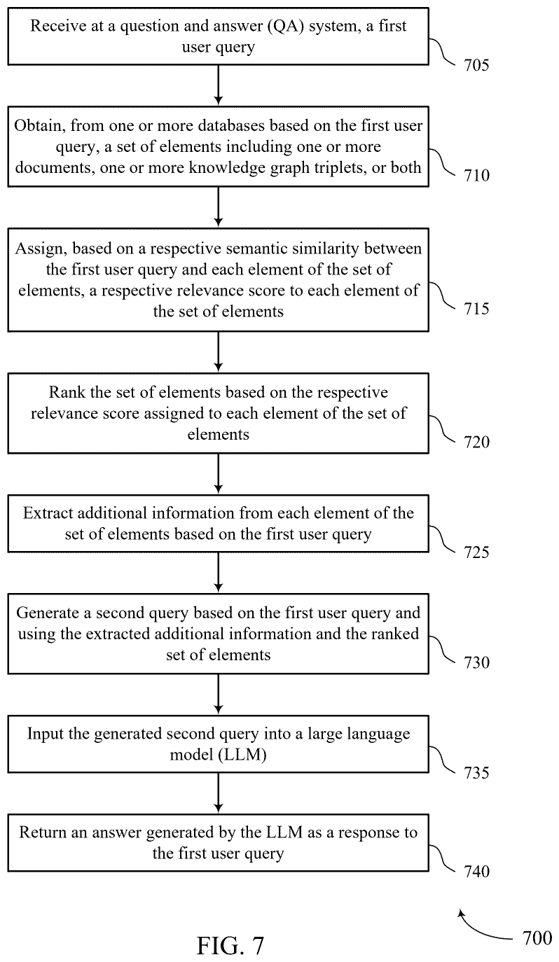

FIG. 7 shows a flowchart illustrating a method 700 that supports RAG based query reformulation pipeline for a QA system in accordance with aspects of the present disclosure. The operations of the method 700 may be implemented by a server or its components as described herein. For example, the operations of the method 700 may be performed by a server as described with reference to FIGS. 1 through 6. In some examples, a server may execute a set of instructions to control the functional elements of the server to perform the described functions. Additionally, or alternatively, the server may perform aspects of the described functions using special-purpose hardware.

At 705, the method may include receiving at a QA system, a first user query. The operations of 705 may be performed in accordance with examples as disclosed herein. In some examples, aspects of the operations of 705 may be performed by a query interface 525 as described with reference to FIG. 5.

At 710, the method may include obtaining, from one or more databases based on the first user query, a set of elements including one or more documents, one or more knowledge graph triplets, or both. The operations of 710 may be performed in accordance with examples as disclosed herein. In some examples, aspects of the operations of 710 may be performed by a data interface 530 as described with reference to FIG. 5.

At 715, the method may include assigning, based on a respective semantic similarity between the first user query and each element of the set of elements, a respective relevance score to each element of the set of elements. The operations of 715 may be performed in accordance with examples as disclosed herein. In some examples, aspects of the operations of 715 may be performed by a relevance score component 535 as described with reference to FIG. 5.

At 720, the method may include ranking the set of elements based on the respective relevance score assigned to each element of the set of elements. The operations of 720 may be performed in accordance with examples as disclosed herein. In some examples, aspects of the operations of 720 may be performed by an element ranking component 540 as described with reference to FIG. 5.

At 725, the method may include extracting additional information from each element of the set of elements based on the first user query. The operations of 725 may be performed in accordance with examples as disclosed herein. In some examples, aspects of the operations of 725 may be performed by a refinement and summarization component 545 as described with reference to FIG. 5.

At 730, the method may include generating a second query based on the first user query and using the extracted additional information and the ranked set of elements. The operations of 730 may be performed in accordance with examples as disclosed herein. In some examples, aspects of the operations of 730 may be performed by a query reformulation component 550 as described with reference to FIG. 5.

At 735, the method may include inputting the generated second query into an LLM. The operations of 735 may be performed in accordance with examples as disclosed herein. In some examples, aspects of the operations of 735 may be performed by an LLM interface 555 as described with reference to FIG. 5.

At 740, the method may include returning an answer generated by the LLM as a response to the first user query. The operations of 740 may be performed in accordance with examples as disclosed herein. In some examples, aspects of the operations of 740 may be performed by an answer interface 560 as described with reference to FIG. 5.

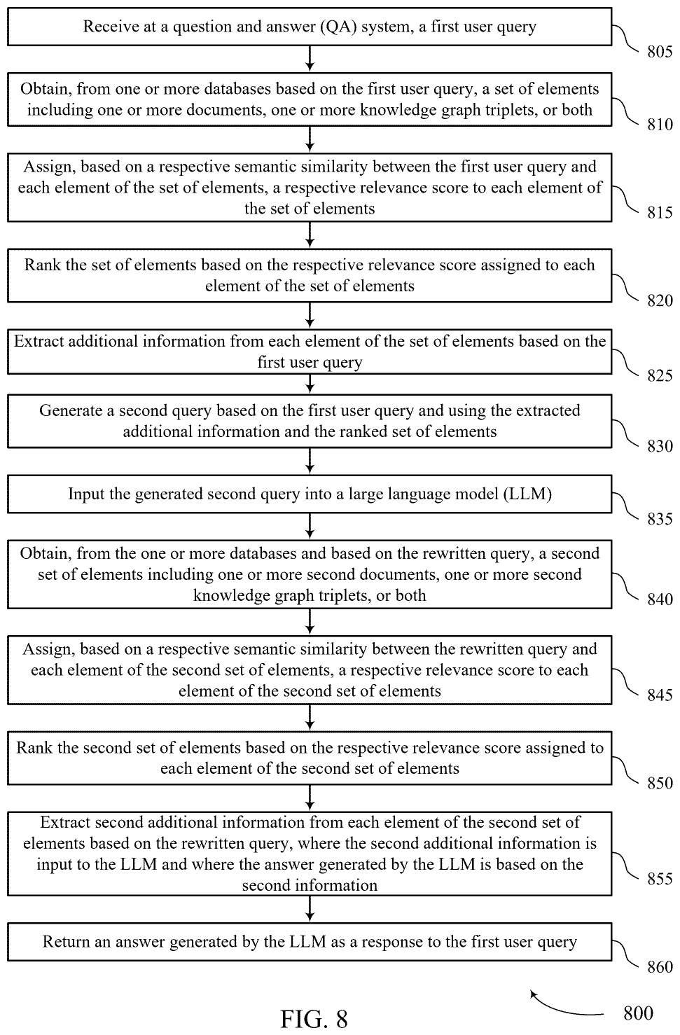

FIG. 8 shows a flowchart illustrating a method 800 that supports RAG based query reformulation pipeline for a QA system in accordance with aspects of the present disclosure. The operations of the method 800 may be implemented by a server or its components as described herein. For example, the operations of the method 800 may be performed by a server as described with reference to FIGS. 1 through 6. In some examples, a server may execute a set of instructions to control the functional elements of the server to perform the described functions. Additionally, or alternatively, the server may perform aspects of the described functions using special-purpose hardware.

At 805, the method may include receiving at a QA system, a first user query. The operations of 805 may be performed in accordance with examples as disclosed herein. In some examples, aspects of the operations of 805 may be performed by a query interface 525 as described with reference to FIG. 5.

At 810, the method may include obtaining, from one or more databases based on the first user query, a set of elements including one or more documents, one or more knowledge graph triplets, or both. The operations of 810 may be performed in accordance with examples as disclosed herein. In some examples, aspects of the operations of 810 may be performed by a data interface 530 as described with reference to FIG. 5.

At 815, the method may include assigning, based on a respective semantic similarity between the first user query and each element of the set of elements, a respective relevance score to each element of the set of elements. The operations of 815 may be performed in accordance with examples as disclosed herein. In some examples, aspects of the operations of 815 may be performed by a relevance score component 535 as described with reference to FIG. 5.

At 820, the method may include ranking the set of elements based on the respective relevance score assigned to each element of the set of elements. The operations of 820 may be performed in accordance with examples as disclosed herein. In some examples, aspects of the operations of 820 may be performed by an element ranking component 540 as described with reference to FIG. 5.

At 825, the method may include extracting additional information from each element of the set of elements based on the first user query. The operations of 825 may be performed in accordance with examples as disclosed herein. In some examples, aspects of the operations of 825 may be performed by a refinement and summarization component 545 as described with reference to FIG. 5.

At 830, the method may include generating a second query based on the first user query and using the extracted additional information and the ranked set of elements. The operations of 830 may be performed in accordance with examples as disclosed herein. In some examples, aspects of the operations of 830 may be performed by a query reformulation component 550 as described with reference to FIG. 5.

At 835, the method may include inputting the generated second query into an LLM. The operations of 835 may be performed in accordance with examples as disclosed herein. In some examples, aspects of the operations of 835 may be performed by an LLM interface 555 as described with reference to FIG. 5.

At 840, the method may include obtaining, from the one or more databases and based on the rewritten query, a second set of elements including one or more second documents, one or more second knowledge graph triplets, or both. The operations of 840 may be performed in accordance with examples as disclosed herein. In some examples, aspects of the operations of 840 may be performed by a data interface 530 as described with reference to FIG. 5.

At 845, the method may include assigning, based on a respective semantic similarity between the rewritten query and each element of the second set of elements, a respective relevance score to each element of the second set of elements. The operations of 845 may be performed in accordance with examples as disclosed herein. In some examples, aspects of the operations of 845 may be performed by a relevance score component 535 as described with reference to FIG. 5.

At 850, the method may include ranking the second set of elements based on the respective relevance score assigned to each element of the second set of elements. The operations of 850 may be performed in accordance with examples as disclosed herein. In some examples, aspects of the operations of 850 may be performed by an element ranking component 540 as described with reference to FIG. 5.

At 855, the method may include extracting second additional information from each element of the second set of elements based on the rewritten query, where the second additional information is input to the LLM and where the answer generated by the LLM is based on the second information. The operations of 855 may be performed in accordance with examples as disclosed herein. In some examples, aspects of the operations of 855 may be performed by a refinement and summarization component 545 as described with reference to FIG. 5.

At 860, the method may include returning an answer generated by the LLM as a response to the first user query. The operations of 860 may be performed in accordance with examples as disclosed herein. In some examples, aspects of the operations of 860 may be performed by an answer interface 560 as described with reference to FIG. 5.

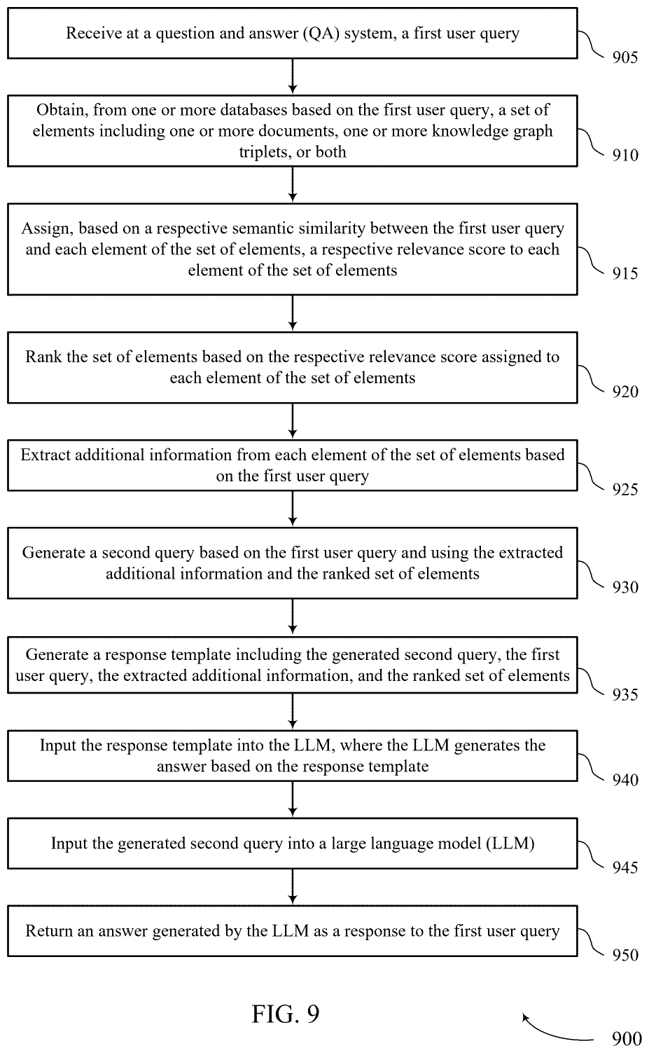

FIG. 9 shows a flowchart illustrating a method 900 that supports RAG based query reformulation pipeline for a QA system in accordance with aspects of the present disclosure. The operations of the method 900 may be implemented by a server or its components as described herein. For example, the operations of the method 900 may be performed by a server as described with reference to FIGS. 1 through 6. In some examples, a server may execute a set of instructions to control the functional elements of the server to perform the described functions. Additionally, or alternatively, the server may perform aspects of the described functions using special-purpose hardware.

At 905, the method may include receiving at a QA system, a first user query. The operations of 905 may be performed in accordance with examples as disclosed herein. In some examples, aspects of the operations of 905 may be performed by a query interface 525 as described with reference to FIG. 5.

At 910, the method may include obtaining, from one or more databases based on the first user query, a set of elements including one or more documents, one or more knowledge graph triplets, or both. The operations of 910 may be performed in accordance with examples as disclosed herein. In some examples, aspects of the operations of 910 may be performed by a data interface 530 as described with reference to FIG. 5.

At 915, the method may include assigning, based on a respective semantic similarity between the first user query and each element of the set of elements, a respective relevance score to each element of the set of elements. The operations of 915 may be performed in accordance with examples as disclosed herein. In some examples, aspects of the operations of 915 may be performed by a relevance score component 535 as described with reference to FIG. 5.

At 920, the method may include ranking the set of elements based on the respective relevance score assigned to each element of the set of elements. The operations of 920 may be performed in accordance with examples as disclosed herein. In some examples, aspects of the operations of 920 may be performed by an element ranking component 540 as described with reference to FIG. 5.

At 925, the method may include extracting additional information from each element of the set of elements based on the first user query. The operations of 925 may be performed in accordance with examples as disclosed herein. In some examples, aspects of the operations of 925 may be performed by a refinement and summarization component 545 as described with reference to FIG. 5.

At 930, the method may include generating a second query based on the first user query and using the extracted additional information and the ranked set of elements. The operations of 930 may be performed in accordance with examples as disclosed herein. In some examples, aspects of the operations of 930 may be performed by a query reformulation component 550 as described with reference to FIG. 5.

At 935, the method may include generating a response template including the generated second query, the first user query, the extracted additional information, and the ranked set of elements, where the response template includes formatting elements. The operations of 935 may be performed in accordance with examples as disclosed herein. In some examples, aspects of the operations of 935 may be performed by a response template component 570 as described with reference to FIG. 5.

At 940, the method may include inputting the response template into the LLM, where the LLM generates the answer based on the response template. The operations of 940 may be performed in accordance with examples as disclosed herein. In some examples, aspects of the operations of 940 may be performed by a response template interface 575 as described with reference to FIG. 5.

At 945, the method may include inputting the generated second query into an LLM. The operations of 945 may be performed in accordance with examples as disclosed herein. In some examples, aspects of the operations of 945 may be performed by an LLM interface 555 as described with reference to FIG. 5.

At 950, the method may include returning an answer generated by the LLM as a response to the first user query. The operations of 950 may be performed in accordance with examples as disclosed herein. In some examples, aspects of the operations of 950 may be performed by an answer interface 560 as described with reference to FIG. 5.

A method by an apparatus is described. The method may include receiving at a QA system, a first user query, obtaining, from one or more databases based on the first user query, a set of elements including one or more documents, one or more knowledge graph triplets, or both, assigning, based on a respective semantic similarity between the first user query and each element of the set of elements, a respective relevance score to each element of the set of elements, ranking the set of elements based on the respective relevance score assigned to each element of the set of elements, extracting additional information from each element of the set of elements based on the first user query, generating a second query based on the first user query and using the extracted additional information and the ranked set of elements, inputting the generated second query into an LLM, and returning an answer generated by the LLM as a response to the first user query.

An apparatus is described. The apparatus may include one or more memories storing processor executable code, and one or more processors coupled with the one or more memories. The one or more processors may individually or collectively be operable to execute the code to cause the apparatus to receive at a QA system, a first user query, obtain, from one or more databases based on the first user query, a set of elements including one or more documents, one or more knowledge graph triplets, or both, assign, based on a respective semantic similarity between the first user query and each element of the set of elements, a respective relevance score to each element of the set of elements, rank the set of elements based on the respective relevance score assigned to each element of the set of elements, extract additional information from each element of the set of elements based on the first user query, generate a second query based on the first user query and using the extracted additional information and the ranked set of elements, input the generated second query into an LLM, and return an answer generated by the LLM as a response to the first user query.

Another apparatus is described. The apparatus may include means for receiving at a QA system, a first user query, means for obtaining, from one or more databases based on the first user query, a set of elements including one or more documents, one or more knowledge graph triplets, or both, means for assigning, based on a respective semantic similarity between the first user query and each element of the set of elements, a respective relevance score to each element of the set of elements, means for ranking the set of elements based on the respective relevance score assigned to each element of the set of elements, means for extracting additional information from each element of the set of elements based on the first user query, means for generating a second query based on the first user query and using the extracted additional information and the ranked set of elements, means for inputting the generated second query into an LLM, and means for returning an answer generated by the LLM as a response to the first user query.

A non-transitory computer-readable medium storing code is described. The code may include instructions executable by one or more processors to receive at a QA system, a first user query, obtain, from one or more databases based on the first user query, a set of elements including one or more documents, one or more knowledge graph triplets, or both, assign, based on a respective semantic similarity between the first user query and each element of the set of elements, a respective relevance score to each element of the set of elements, rank the set of elements based on the respective relevance score assigned to each element of the set of elements, extract additional information from each element of the set of elements based on the first user query, generate a second query based on the first user query and using the extracted additional information and the ranked set of elements, input the generated second query into an LLM, and return an answer generated by the LLM as a response to the first user query.

In some examples of the method, apparatus, and non-transitory computer-readable medium described herein, the QA system includes a DAG structure configured to generate the second query based on the first user query.

In some examples of the method, apparatus, and non-transitory computer-readable medium described herein, the QA system operates in accordance with a smart mode or thoughtful mode, and the DAG structure may be dependent on whether the QA system may be in the smart mode or the thoughtful mode.

In some examples of the method, apparatus, and non-transitory computer-readable medium described herein, when operating in accordance with the smart mode, the DAG structure includes a first set of nodes and when operating in accordance with the thoughtful mode, the DAG structure includes a second set of nodes.

Some examples of the method, apparatus, and non-transitory computer-readable medium described herein may further include operations, features, means, or instructions for obtaining, from the one or more databases and based on the rewritten query, a second set of elements including one or more second documents, one or more second knowledge graph triplets, or both, assigning, based on a respective semantic similarity between the rewritten query and each element of the second set of elements, a respective relevance score to each element of the second set of elements, ranking the second set of elements based on the respective relevance score assigned to each element of the second set of elements, and extracting second additional information from each element of the second set of elements based on the rewritten query, where the second additional information may be input to the LLM and where the answer generated by the LLM may be based on the second information.

In some examples of the method, apparatus, and non-transitory computer-readable medium described herein, the one or more knowledge graph triplets may be obtained from one or more knowledge graphs generated by the LLM from a corpus of documents and each knowledge graph triplet includes a subject element, a relationship element, and an object element.

In some examples of the method, apparatus, and non-transitory computer-readable medium described herein, inputting the generated second query into the LLM may include operations, features, means, or instructions for generating a response template including the generated second query, the first user query, the extracted additional information, and the ranked set of elements; where the response template includes formatting elements and inputting the response template into the LLM, where the LLM generates the answer based on the response template.

The following provides an overview of aspects of the present disclosure:

Aspect 1: A method, comprising: receiving at a QA system, a first user query; obtaining, from one or more databases based at least in part on the first user query, a set of elements comprising one or more documents, one or more knowledge graph triplets, or both; assigning, based at least in part on a respective semantic similarity between the first user query and each element of the set of elements, a respective relevance score to each element of the set of elements; ranking the set of elements based at least in part on the respective relevance score assigned to each element of the set of elements; extracting additional information from each element of the set of elements based at least in part on the first user query; generating a second query based at least in part on the first user query and using the extracted additional information and the ranked set of elements; inputting the generated second query into an LLM; and returning an answer generated by the LLM as a response to the first user query.

Aspect 2: The method of aspect 1, wherein the QA system comprises a DAG structure configured to generate the second query based on the first user query.

Aspect 3: The method of aspect 2, wherein the QA system operates in accordance with a smart mode or thoughtful mode, and the DAG structure is dependent on whether the QA system is in the smart mode or the thoughtful mode.

Aspect 4: The method of aspect 3, wherein when operating in accordance with the smart mode, the DAG structure includes a first set of nodes, and when operating in accordance with the thoughtful mode, the DAG structure includes a second set of nodes.

Aspect 5: The method of any of aspects 1 through 4, wherein inputting the generated second query into the LLM results in a rewritten query, further comprising: obtaining, from the one or more databases and based at least in part on the rewritten query, a second set of elements comprising one or more second documents, one or more second knowledge graph triplets, or both; assigning, based at least in part on a respective semantic similarity between the rewritten query and each element of the second set of elements, a respective relevance score to each element of the second set of elements; ranking the second set of elements based at least in part on the respective relevance score assigned to each element of the second set of elements; and extracting second additional information from each element of the second set of elements based at least in part on the rewritten query, wherein the second additional information is input to the LLM and wherein the answer generated by the LLM is based at least in part on the second information.

Aspect 6: The method of any of aspects 1 through 5, wherein the one or more knowledge graph triplets are obtained from one or more knowledge graphs generated by the LLM from a corpus of documents, and each knowledge graph triplet comprises a subject element, a relationship element, and an object element.

Aspect 7: The method of any of aspects 1 through 6, wherein inputting the generated second query into the LLM comprises: generating a response template comprising the generated second query, the first user query, the extracted additional information, and the ranked set of elements; wherein the response template includes formatting elements; and inputting the response template into the LLM, wherein the LLM generates the answer based on the response template.

Aspect 8: An apparatus comprising one or more memories storing processor-executable code, and one or more processors coupled with the one or more memories and individually or collectively operable to execute the code to cause the apparatus to perform a method of any of aspects 1 through 7.

Aspect 9: An apparatus comprising at least one means for performing a method of any of aspects 1 through 7.

Aspect 10: A non-transitory computer-readable medium storing code the code comprising instructions executable by one or more processors to perform a method of any of aspects 1 through 7.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
receiving at a question and answer (QA) system, a first user query;
obtaining, from one or more databases based at least in part on the first user query, a set of elements comprising one or more documents, one or more knowledge graph triplets, or both;
assigning, based at least in part on a respective semantic similarity between the first user query and each element of the set of elements, a respective relevance score to each element of the set of elements;
ranking the set of elements based at least in part on the respective relevance score assigned to each element of the set of elements;
extracting additional information from each element of the set of elements based at least in part on the first user query;
generating a second query based at least in part on the first user query and using the extracted additional information and the ranked set of elements;
inputting the generated second query into a large language model (LLM); and
returning an answer generated by the LLM as a response to the first user query.

2. The method of claim 1, wherein the QA system comprises a directed acyclic graph (DAG) structure configured to generate the second query based on the first user query.

3. The method of claim 2, wherein the QA system operates in accordance with a smart mode or thoughtful mode, and the DAG structure is dependent on whether the QA system is in the smart mode or the thoughtful mode.

4. The method of claim 3, wherein:
when operating in accordance with the smart mode, the DAG structure includes a first set of nodes, and
when operating in accordance with the thoughtful mode, the DAG structure includes a second set of nodes.

5. The method of claim 1, wherein inputting the generated second query into the LLM results in a rewritten query, further comprising:
obtaining, from the one or more databases and based at least in part on the rewritten query, a second set of elements comprising one or more second documents, one or more second knowledge graph triplets, or both;
assigning, based at least in part on a respective semantic similarity between the rewritten query and each element of the second set of elements, a respective relevance score to each element of the second set of elements;
ranking the second set of elements based at least in part on the respective relevance score assigned to each element of the second set of elements; and
extracting second additional information from each element of the second set of elements based at least in part on the rewritten query, wherein the second additional information is input to the LLM and wherein the answer generated by the LLM is based at least in part on the second information.

6. The method of claim 1, wherein:
the one or more knowledge graph triplets are obtained from one or more knowledge graphs generated by the LLM from a corpus of documents, and
each knowledge graph triplet comprises a subject element, a relationship element, and an object element.

7. The method of claim 1, wherein inputting the generated second query into the LLM comprises:
generating a response template comprising the generated second query, the first user query, the extracted additional information, and the ranked set of elements; wherein the response template includes formatting elements; and
inputting the response template into the LLM, wherein the LLM generates the answer based on the response template.

8. An apparatus, comprising:
one or more memories storing processor-executable code; and
one or more processors coupled with the one or more memories and individually or collectively operable to execute the code to cause the apparatus to:
receive at a question and answer (QA) system, a first user query;
obtain, from one or more databases based at least in part on the first user query, a set of elements comprising one or more documents, one or more knowledge graph triplets, or both;
assign, based at least in part on a respective semantic similarity between the first user query and each element of the set of elements, a respective relevance score to each element of the set of elements;
rank the set of elements based at least in part on the respective relevance score assigned to each element of the set of elements;
extract additional information from each element of the set of elements based at least in part on the first user query;
generate a second query based at least in part on the first user query and using the extracted additional information and the ranked set of elements;
input the generated second query into a large language model (LLM); and
return an answer generated by the LLM as a response to the first user query.

9. The apparatus of claim 8, wherein the QA system comprises a directed acyclic graph (DAG) structure configured to generate the second query based on the first user query.

10. The apparatus of claim 9, wherein the QA system operates in accordance with a smart mode or thoughtful mode, and the DAG structure is dependent on whether the QA system is in the smart mode or the thoughtful mode.

11. The apparatus of claim 10, wherein:
when operating in accordance with the smart mode, the DAG structure includes a first set of nodes, and
when operating in accordance with the thoughtful mode, the DAG structure includes a second set of nodes.

12. The apparatus of claim 8, wherein the one or more processors are individually or collectively further operable to execute the code to cause the apparatus to:
obtain, from the one or more databases and based at least in part on the rewritten query, a second set of elements comprising one or more second documents, one or more second knowledge graph triplets, or both;
assign, based at least in part on a respective semantic similarity between the rewritten query and each element of the second set of elements, a respective relevance score to each element of the second set of elements;
rank the second set of elements based at least in part on the respective relevance score assigned to each element of the second set of elements; and
extract second additional information from each element of the second set of elements based at least in part on the rewritten query, wherein the second additional information is input to the LLM and wherein the answer generated by the LLM is based at least in part on the second information.

13. The apparatus of claim 8, wherein:
the one or more knowledge graph triplets are obtained from one or more knowledge graphs generated by the LLM from a corpus of documents, and
each knowledge graph triplet comprises a subject element, a relationship element, and an object element.

14. The apparatus of claim 8, wherein, to input the generated second query into the LLM, the one or more processors are individually or collectively operable to execute the code to cause the apparatus to:
generate a response template comprising the generated second query, the first user query, the extracted additional information, and the ranked set of elements; wherein the response template includes formatting elements; and
input the response template into the LLM, wherein the LLM generates the answer based on the response template.

15. A non-transitory computer-readable medium storing code, the code comprising instructions executable by one or more processors to:
receive at a question and answer (QA) system, a first user query;
obtain, from one or more databases based at least in part on the first user query, a set of elements comprising one or more documents, one or more knowledge graph triplets, or both;
assign, based at least in part on a respective semantic similarity between the first user query and each element of the set of elements, a respective relevance score to each element of the set of elements;
rank the set of elements based at least in part on the respective relevance score assigned to each element of the set of elements;
extract additional information from each element of the set of elements based at least in part on the first user query;
generate a second query based at least in part on the first user query and using the extracted additional information and the ranked set of elements;
input the generated second query into a large language model (LLM); and
return an answer generated by the LLM as a response to the first user query.

16. The non-transitory computer-readable medium of claim 15, wherein the QA system comprises a directed acyclic graph (DAG) structure configured to generate the second query based on the first user query.

17. The non-transitory computer-readable medium of claim 16, wherein the QA system operates in accordance with a smart mode or thoughtful mode, and the DAG structure is dependent on whether the QA system is in the smart mode or the thoughtful mode.

18. The non-transitory computer-readable medium of claim 17, wherein:
when operating in accordance with the smart mode, the DAG structure includes a first set of nodes, and
when operating in accordance with the thoughtful mode, the DAG structure includes a second set of nodes.

19. The non-transitory computer-readable medium of claim 15, wherein the instructions are further executable by the one or more processors to:
obtain, from the one or more databases and based at least in part on the rewritten query, a second set of elements comprising one or more second documents, one or more second knowledge graph triplets, or both;
assign, based at least in part on a respective semantic similarity between the rewritten query and each element of the second set of elements, a respective relevance score to each element of the second set of elements;
rank the second set of elements based at least in part on the respective relevance score assigned to each element of the second set of elements; and
extract second additional information from each element of the second set of elements based at least in part on the rewritten query, wherein the second additional information is input to the LLM and wherein the answer generated by the LLM is based at least in part on the second information.

20. The non-transitory computer-readable medium of claim 15, wherein:
the one or more knowledge graph triplets are obtained from one or more knowledge graphs generated by the LLM from a corpus of documents, and
each knowledge graph triplet comprises a subject element, a relationship element, and an object element.
